(19) United States
(12) Patent Application Publication
(10) Pub. No.: US 2007/0174900 A1
(43) Pub. Date: Jul. 26, 2007

(54) System and method for establishing a trust model governing interaction and service or program delivery

(76) Inventors: Sunny Marueli, Ramat Hasharon (IL); Tovi Riegler, Ramla (IL); Oren Ahr, Pardes Hana (IL); Adi Ruppin, Ramat Gan (IL)

Correspondence Address: Ms. Ronny Fogel;Brux Software Solutions Ltd., 8 Gordon Street, Givatayim, 53235, omitted

(21) Appl. No.: 11/650,481

(22) Filed: Jan. 8, 2007

Related U.S. Application Data
(60) Provisional application No. 60/761,304, filed on Jan. 24, 2006.

(51) Int. Cl. H04L 9/32

(52) U.S. Cl. 726/4

(57) ABSTRACT

A hierarchical communication system and method, comprising a network; end-users of the network, at least part of said end-users requiring supervision; guardians providing supervision to said end-users requiring supervision; and means, connected with said network, for authorizing communication between two or more end-users requiring supervision or between an end-user requiring supervision and an end-user not requiring supervision.

### CROSS-REFERENCE TO RELATED PATENT APPLICATIONS

This patent application claims priority from and is related to U.S. Provisional Patent Application Serial Number 60/761,304, filed Jan. 24, 2006, this U.S. Provisional Patent Application incorporated by reference in its entirety herein.

### FIELD OF INVENTION

The present invention relates to a system and method for enabling children and other dependants to safely interact and perform transactions over a communications network.

### BACKGROUND OF THE INVENTION

U.S. Published application No. 20040003071 to Mathew et als, discloses a system for enabling a user and an administrator in a network environment to interactively customize administrator controls used to filter the user's online actions. The invention is limited to interaction between the user and the administrator and is based on pre-defined rules that may be changed upon request.

U.S. Published application No. 20040083367 to Garg et als, discloses a role-based authorization management system maintains an authorization policy store that represents user authorizations to perform operations associated with an application. When a user attempts to perform a function associated with an application, the authorization management system verifies that the user is authorized to perform the requested function. The authorization management system also provides an interface for an application administrator to update role-based user authorization policies associated with one or more applications.

U.S. Published application No. 20020049806 to Gatz et als, discloses an access server controls use of services in an account based access server and includes a database of users, a data structure associating users identified as parents with parent accounts, users identified as children with child accounts and associating parent accounts with child accounts in family accounts. The access server includes logic for verifying parental status of a parent account with respect to a child account and logic for limiting access to a user using a child account that is associated with a family account, where such limitations are determined, at least in part, based on selections made by a user of a parent account associated with the family account.

Published application EP1471476 to Gautier et als, discloses methods and systems for network-based allowance control are disclosed. A user creates an allowance in association with a recipient account such that funds are available in the recipient account for use by a recipient for the purchase of goods over a network (e.g., Internet). Specifically, by creating an allowance, a user initiates a periodic (recurring) transfer (i.e., credit) of an amount of money (i.e., funds) to the recipient account. This money may then be used by the recipient for the purchase of goods over the network. The recipient account may be related to a parent account as a sub-account, enabling the user of the parent account to monitor purchases made by the recipient, as well as limit the items that can be purchased by the recipient.

All these and other prior art references do not relate to the problem of bi-lateral communication between children or other persons needing supervision, nor do they provide for ad-hoc communication between supervisors to allow or forbid such a bi-lateral communication, or a communication between a child and a service provider.

### SUMMARY OF THE INVENTION

The present invention provides a system and method for parents (or other guardians such as teachers) to secure, authenticate and authorize interaction of their children (or other dependant users) with others in an anonymous networking environment such as the Internet. In addition, the method can authorize and control the acquisition or purchase of products or services over the networking environment.

Specifically, the system and method can be used to protect children from malicious persons on the Internet, by allowing Guardians (such as parents) to apply their discretion upon any attempt to initiate an interaction between the child and an entity (or vice versa) over the network. Additionally, transactions such as buying a product or using a service may be sanctioned by the guardian.

Unlike present Instant Messengers or Chat Rooms, this system and method establish a trust between the End User and Guardian and then between Guardians or between Guardians and providers of services. This way, End Users may only interact or transact if trust has been established by their respective Guardians and the activity was approved by the Guardians. Unknown or malicious entities cannot communicate in any way with the End User, unless the Guardian has specifically allowed it.

Thus, according to a first aspect of the present invention, there is provided a hierarchical communication system comprising a network; end-users of said network, at least part of said end-users requiring supervision; guardians providing supervision to said end-users requiring supervision; and means, connected with said network, for authorizing communication between two or more end-users requiring supervision or between an end-user requiring supervision and an end-user not requiring supervision.

According to a first embodiment, the means for authorizing communication comprise means for identifying and authenticating a guardian's identity.

According to a second embodiment, the means for identifying and authenticating are selected from the group consisting of name, social security number and credit card number.

According to a third embodiment, the means for authorizing communication comprise means for establishing rules for banning or authorizing said communication.

According to a fourth embodiment, the means for authorizing communication between two or more end-users requiring supervision comprise means for receiving a request from a first end-user to communicate with a second end-user; means for communicating said request to said first and second end-users' guardians; and means for authorizing or denying said communication request, based on at least one of said guardians' responses and pre-established rules.

According to a fifth embodiment, the system additionally comprises means for establishing direct communication between said respective guardians.

According to a sixth embodiment, the means for authorizing communication between an end-user requiring supervision and an end-user not requiring supervision comprise means for receiving a request from a first end-user requiring supervision to communicate with a second end-user not requiring supervision; means for communicating said request to said first user's guardian; and means for authorizing or denying said communication request based on at least one of said guardian's response and pre-established rules.

According to a seventh embodiment, the means for authorizing communication between an end-user requiring supervision and an end-user not requiring supervision comprise means for receiving a request from a first end-user not requiring supervision to communicate with a second end-user requiring supervision; means for communicating said request to said second users' guardians; and means for authorizing or denying said communication request based on at least one of said guardians' response and pre-established rules.

According to an eighth embodiment, the end-user not requiring supervision comprises a service or merchandise provider.

According to a ninth embodiment, the means for authorizing communication between an end-user requiring supervision and a service or merchandise provider comprise means for receiving a request from said end-user requiring supervision to purchase a service or a merchandise from said provider; means for communicating said transaction request to said end-user's guardians; and means for authorizing or denying said communication request based on at least one of said guardians' response and pre-established rule.

According to a tenth embodiment, the system additionally comprises means for performing the transaction, selected from the group consisting of credit card payment, bank transfer and pre-paid allowance.

According to a second aspect of the present invention, there is provided a method of supervising network communication between two or more end-users requiring supervision, comprising the steps of: appointing a guardian to each said end-users requiring supervision; authenticating said guardian's identity; and authorizing communication between said two or more end-users only if all the respective guardians have authorized the communication.

According to a first embodiment, the step of authorizing the communication comprises the steps of: receiving a request from a first end-user to communicate with a second end-user; communicating said request to said first and second end-users' guardians; and authorizing or denying said communication request based on at least one of said guardians' responses and pre-established rules.

According to a second embodiment, the method additionally comprises the step of establishing direct communication between said respective guardians.

According to a third aspect of the present invention, there is provided a method of supervising network communication between an end-user requiring supervision and an end-user not requiring supervision comprising the steps of: receiving a request from a first end-user requiring supervision to communicate with a second end-user not requiring supervision; communicating said request to said first end-user's guardian; and authorizing or denying said communication request based on at least one of said guardian's response and pre-established rules.

According to a first embodiment, the end-user not requiring supervision comprises a service or merchandise provider.

According to a second embodiment, the method additionally comprises the step of performing a transaction with said service or merchandise provider.

According to a fourth aspect of the present invention, there is provided a method of supervising network communication between an end-user requiring supervision and an end-user not requiring supervision comprising the steps of: receiving a request from a first end-user not requiring supervision to communicate with a second end-user requiring supervision; communicating said request to said second user's guardian; and authorizing or denying said communication request based on at least one of said guardian's response and pre-established rules.

### BRIEF DESCRIPTION OF DRAWINGS

For a better understanding of the invention, its operating advantages and the specific objects attained by its uses, reference should be made to the accompanying drawings, in which:

FIG. 1 shows the general structure of the system and its environment;

FIG. 2 shows the first-time setup process of an end-node;

FIG. 3 describes the process required for one user of the system to initiate interaction with another user of the system;

FIG. 4 describes the authorization process when interaction is requested between two users for the first time; and

FIG. 5 extends the system to interact with other entities that provide some service.

### DETAILED DESCRIPTION OF THE INVENTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention provides a hierarchical system and method for parents (or other guardians such as teachers) to secure, authenticate and to authorize interaction of their children (or other dependants) with others in an anonymous networking environment such as the Internet. In addition, the method can authorize and control the acquisition or purchase of products or services over the networking environment.

Specifically, the system and method can be used to protect children from malicious persons on the Internet, by allowing Guardians (such as parents) to apply their discretion upon any attempt to initiate an interaction between the child and an entity (or vice versa) over the network. Additionally, transactions such as buying a product or using a service may be sanctioned by the guardian.

Unlike present Instant Messengers or Chat Rooms, this system and method establishes a trust between the End User and Guardian and then between Guardians or between Guardians and service providers. This way, End Users may only interact or transact if trust has been established by their respective Guardians and the activity was approved by the Guardians. Unknown or malicious entities cannot communicate in any way with the End User, unless the Guardian has specifically allowed it.

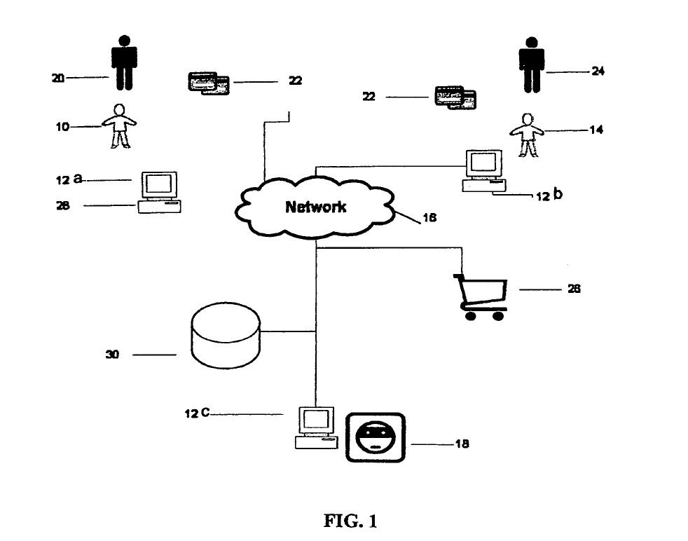

FIG. 1 shows the general structure of the system and its environment. The system comprises a network application 30 managed by a trusted entity such as a commercial entity, a government, or others, and exemplary end-nodes 12a and 12b used by end users 10 and 14 and managed by guardians 20 and 24, respectively. A malicious end-user 18 may gain access to the system via an end-node 12c, acting as a guardian for himself. The network application 30 and the end-nodes 12 connect to a shared communication network 16, such as the Internet. End-nodes 12 are computer systems, such as Personal Computers, that either execute a component of the system locally (‘client’) or alternatively a generic application, such as a web-browser used to access an instance on the system that may execute remotely—for example as part of network application 30.

An entity providing some products or services (‘service provider’) 26 may also connect to the system and to end-users 10, 14 and 18.

### System Setup

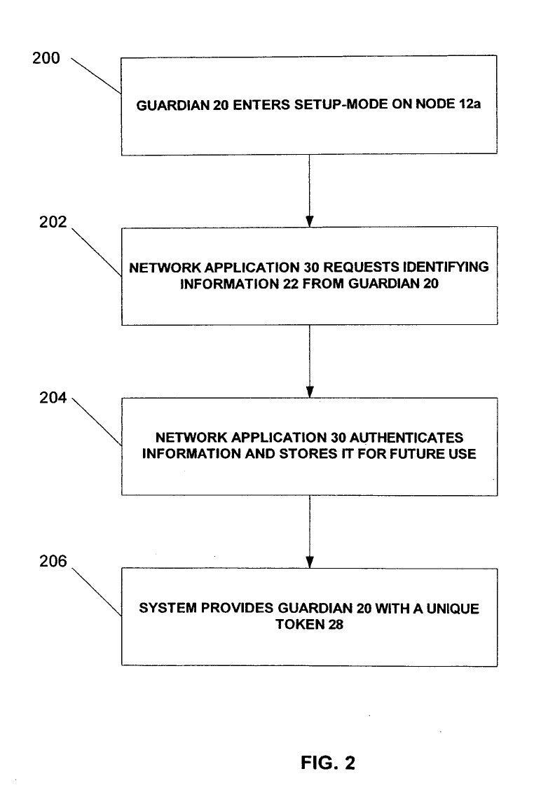

FIG. 2 shows the first-time setup process of an end-node. The setup process takes place before an end-user uses the system for the first time. In step 200, guardian 20 enters the Setup Mode on node 12a; in step 202 Network Application 30 requests identifying information 22 from guardian 20, such as name, social security number, etc. The guardian may additionally provide credit card information and contact information; In step 204 Network Application 30 authenticates the information and stores it for future use; and in step 206 the guardian is provided a unique token for future identification of end-user 10 to Network Application 30.

In the course of the Setup process the guardian may also specify general rules for banning interaction, such as “no purchasing allowed” or “communication with parties from a specific country not allowed”, or specific rules such as “communication with party X not allowed”, or positive indications such as “communication with Y allowed”.

### System Operation

When end-user 10 wishes to use the system (“log-in”), he/she should provide token 28 for authentication with network application 30. Alternatively, the token is stored at, or can be calculated by end-node 12a and provided on behalf of end-user 10.

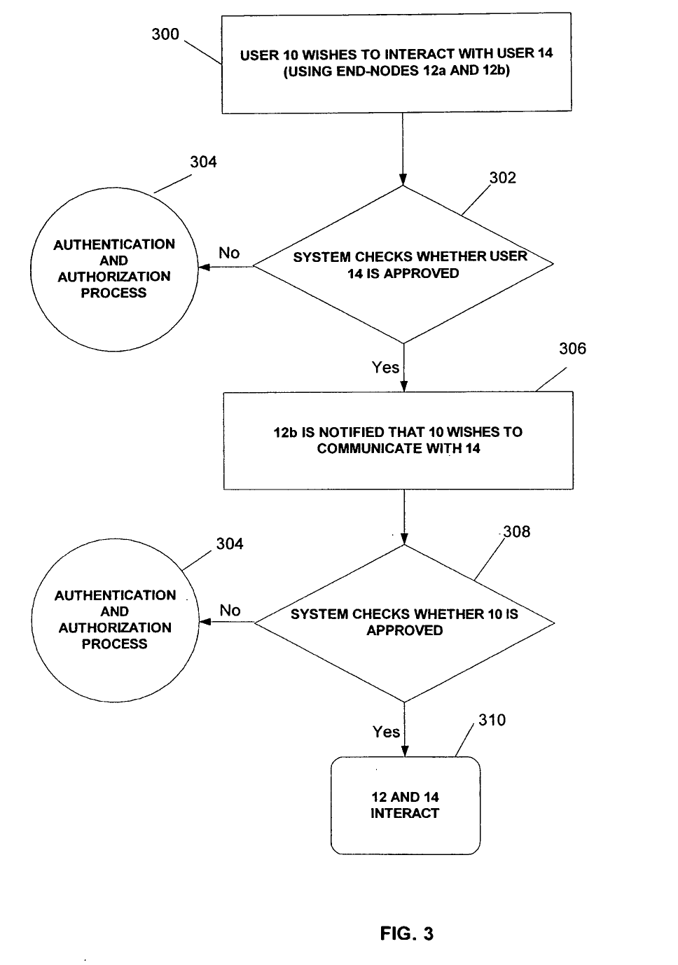

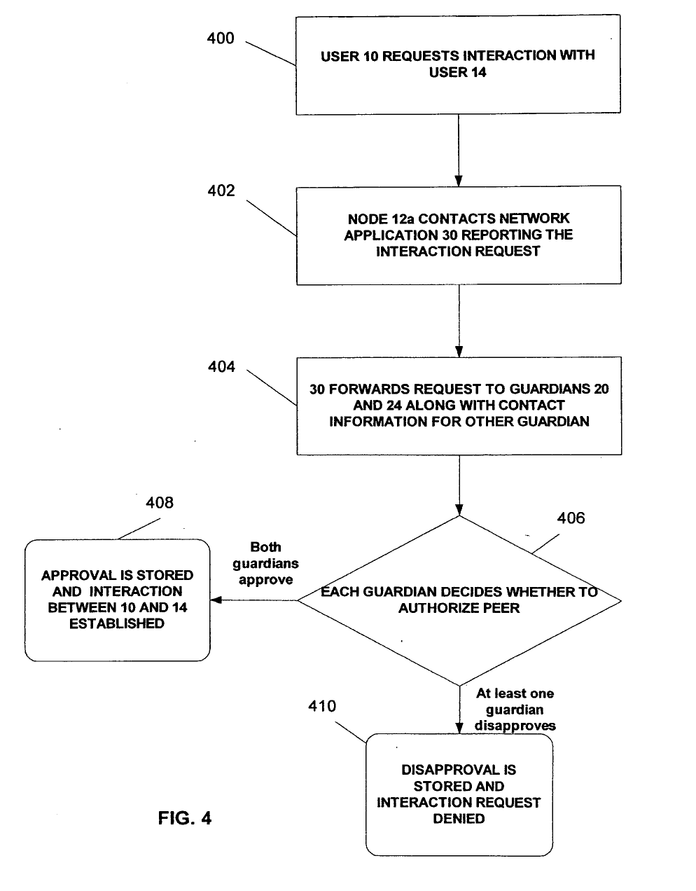

FIG. 3 describes the process required for one user of the system to initiate interaction with another user of the system. When end-user 10 wishes to interact with end-user 14 (step 300), the system—either at both end-nodes or alternatively at the network application 30—checks whether the interaction between users 10 and 14 has already been approved (steps 302, 308), either by a specific rule, during the Setup process, or as a consequence of a previous interaction. Specifically, in step 302 the system checks whether user 14 has been approved for communication with user 10. If affirmative, node 12b is notified that 10 wishes to communicate with 14, and in step 308 12b checks whether 10 is approved for communicating with 14. If it is, the end nodes 12a and 12b may start to communicate via communication network 16 (step 310), allowing users 10 and 14 to interact (by means of instant messaging, audio, video—or any other means supported by technology). If interaction between end-users 10 and 14 has been explicitly banned by either of the guardians (either by a general policy or by a specific rule), interaction will not commence, and optionally the respective end-users or guardians will receive a notification to that effect. If interaction has not been banned, and no policy dictates otherwise, the system will perform an authentication and authorization process (step 304), as described in detail in conjunction with FIG. 4.

In step 400 of FIG. 4, node 12a receives a request from end-user 10 to interact with end-user 14. In step 402 node 12a reports the interaction request to Network Application 30, which, in step 404 contacts both guardians (by any means provided by the guardians at setup time—for example, e-mail, SMS, instant message, or via a message accessible only to the guardian at the end-node itself) and request authorization. Each guardian may provide additional information (either in advance or as part of the authorization process) that the other guardian can use to authorize the requesting guardian (and its dependant). For example, a guardian may provide a phone number allowing the peer guardian to call and establish his identity independently. If both guardians are content with the authentication process they may authorize interaction between the end-users (step 408). On the other hand, if e.g. a malicious user 18 attempts to initiate communications with end user 10, guardian 20 is likely to be better equipped than end-user 10 to identify the nature of end-user 18, and prevent the interaction (step 410). Both approval (step 408) and disapproval (step 410) of the requested communication may be stored, either at the relevant node(s) 12, or in a central store in Network Application 30. Central storage of approved and/or disapproved communications may be beneficial, in that the end user (10, 14) may be directly linked to the database, independent from the node (12a, 12b), thus enabling the user to initiate supervised communications from other nodes.

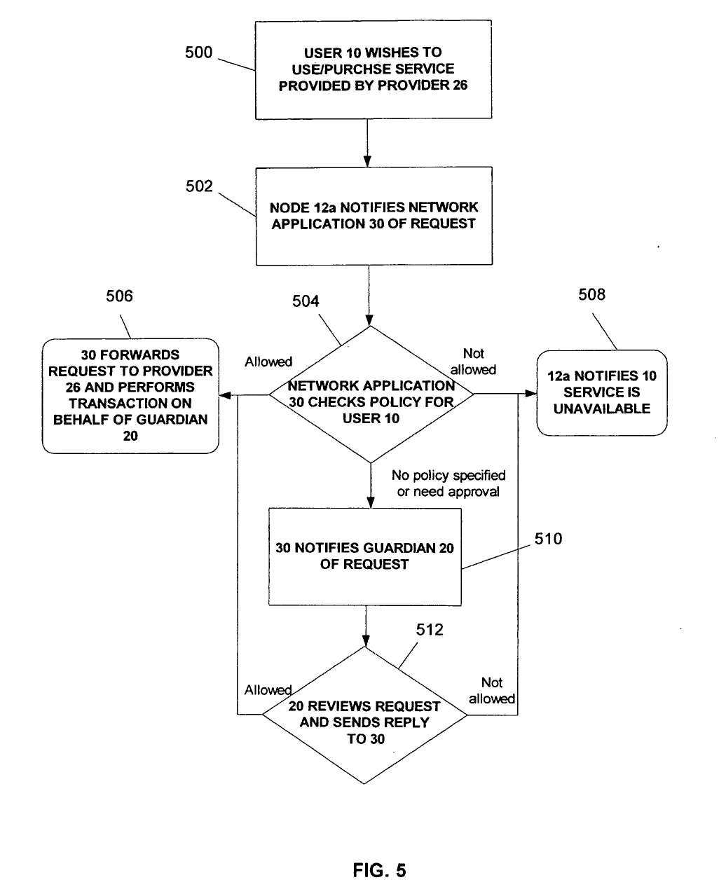

The system can also provide means for end-users to interact with service provider 26, which is also connected to the communication network 16, as shown in FIG. 5. End-user 10 may request access to a service provided by service provider 26 (step 500)—such as a game, or purchase of a product. In step 502 node 12a notifies Network Application 30 of the purchase request. Once the request is made, the system may allow or deny the request based on policy established by guardian 20 either by a general or specific rule (step 504). If no policy is established, or if the policy requires explicit authorization, the service request is forwarded to the guardian 20 (step 510) by means described above. If guardian 20 approves the request, network application 30 will request the service provider 26 to provide the service to end-user 10 (step 506). Otherwise, the system will deny the service (step 508).

This mechanism can also accommodate a financial transaction. For example, end-user 10 may request the purchase of an item provided by service provider 26. However, the transaction itself will only take place after the approval by guardian 20 given as above. Once approval is given, network application 30 will perform a purchase on behalf of user 10, or alternatively forward the purchase request to service provider 26. Payment by guardian 20 for the service supplied by service provider 26 can be made in any established payment method, such as by a credit card (supplied either in advance or as part of the approval), or by a bank to bank transfer. Alternatively, the guardian 20 may provide funds in advance (“pre-paid”) which can then be used by end-user 10 to perform purchases—either requiring an explicit authorization by guardian 20, or with no further authorization (if funds are available). The guardian 20 may set a policy for periodically replenish the funds (“allowance”) if so desired.

Those skilled in the art will appreciate that the conception, upon which this disclosure is based, may readily be utilized as a basis for the designing of other structures, methods and systems for carrying out the several purposes of the present invention.

It is important, therefore, that the claims be regarded as including such equivalent constructions insofar as they do not depart from the spirit and scope of the present invention.

1. A hierarchical communication system comprising:
a network;
end-users of said network, at least part of said end-users requiring supervision;
guardians providing supervision to said end-users requiring supervision; and
means, connected with said network, for authorizing communication between two or more end-users requiring supervision or between an end-user requiring supervision and an end-user not requiring supervision.

2. The system of claim 1, wherein said means for authorizing communication comprise means for identifying and authenticating a guardian's identity.

3. The system of claim 2, wherein said means for identifying and authenticating are selected from the group consisting of name, social security number and credit card number.

4. The system of claim 1, wherein said means for authorizing communication comprise means for establishing rules for banning or authorizing said communication.

5. The system of claim 1, wherein said means for authorizing communication between two or more end-users requiring supervision comprise:
means for receiving a request from a first end-user to communicate with a second end-user;
means for communicating said request to said first and second end-users' guardians; and
means for authorizing or denying said communication request, based on at least one of said guardians' responses and pre-established rules.

6. The system of claim 5, additionally comprising means for establishing direct communication between said respective guardians.

7. The system of claim 1, wherein said means for authorizing communication between an end-user requiring supervision and an end-user not requiring supervision comprise:
means for receiving a request from a first end-user requiring supervision to communicate with a second end-user not requiring supervision;
means for communicating said request to said first user's guardian; and
means for authorizing or denying said communication request based on at least one of said guardian's response and pre-established rules.

8. The system of claim 1, wherein said means for authorizing communication between an end-user requiring supervision and an end-user not requiring supervision comprise:
means for receiving a request from a first end-user not requiring supervision to communicate with a second end-user requiring supervision;
means for communicating said request to said second users' guardians; and
means for authorizing or denying said communication request based on at least one of said guardians' response and pre-established rules.

9. The system of claim 1, wherein said end-user not requiring supervision comprises a service or merchandise provider.

10. The system of claim 9, wherein said means for authorizing communication between an end-user requiring supervision and a service or merchandise provider comprise:
means for receiving a request from said end-user requiring supervision to purchase a service or a merchandise from said provider;
means for communicating said transaction request to said end-user's guardians; and
means for authorizing or denying said communication request based on at least one of said guardians' response and pre-established rule.

11. The system of claim 10, additionally comprising means for performing the transaction, selected from the group consisting of credit card payment, bank transfer and pre-paid allowance.

12. A method of supervising network communication between two or more end-users requiring supervision, comprising the steps of:
appointing a guardian to each said end-users requiring supervision;
authenticating said guardian's identity; and
authorizing communication between said two or more end-users only if all the respective guardians have authorized the communication.

13. The method of claim 12, wherein the step of authorizing the communication comprises the steps of:
receiving a request from a first end-user to communicate with a second end-user;
communicating said request to said first and second end-users' guardians; and
authorizing or denying said communication request based on at least one of said guardians' responses and pre-established rules.

14. The method of claim 13, additionally comprising the step of establishing direct communication between said respective guardians.

15. A method of supervising network communication between an end-user requiring supervision and an end-user not requiring supervision comprising the steps of:
receiving a request from a first end-user requiring supervision to communicate with a second end-user not requiring supervision;
communicating said request to said first end-user's guardian; and
authorizing or denying said communication request based on at least one of said guardian's response and pre-established rules.

16. The method of claim 15, wherein said end-user not requiring supervision comprises a service or merchandise provider.

17. The method of claim 16, additionally comprising the step of performing a transaction with said service or merchandise provider.

18. A method of supervising network communication between an end-user requiring supervision and an end-user not requiring supervision comprising the steps of:
receiving a request from a first end-user not requiring supervision to communicate with a second end-user requiring supervision;
communicating said request to said second user's guardian; and
authorizing or denying said communication request based on at least one of said guardian's response and pre-established rules.
